(19) United States
(12) Patent Application Publication
(10) Pub. No.: US 2011/0035445 A1
(43) Pub. Date: Feb. 10, 2011

(54) SOCIAL NETWORKING SYSTEMS AND METHODS FACILITATING IN-PERSON INTERACTIONS

(76) Inventor: Dale Eickhoff, (US)

Correspondence Address: Mohr Intellectual Property Law Solutions, P.C., 522 SW 5th Avenue, Suite 1390, Portland, OR, 97204-2137, US

(21) Appl. No.: 12/903,997

(22) Filed: Oct. 13, 2010

(51) Int. Cl. G06F 15/16

(52) U.S. Cl. 709/204

(57) ABSTRACT

Social networking systems and methods for facilitating in-person interactions including the steps of storing a user profile for a first user into a database accessible by a networked host computer, the user profile including interest information describing the first user's interests, cross referencing an interest information indicia with the interest information, providing the first user with an indicator that includes the interest information indicia and that is configured to communicate the interest information indicia to nearby users, providing a second user with the interest information of the first user upon the second user accessing the host computer and entering the interest information indicia as a search query. The invention may facilitate in-person interaction, electronic dating, social networking, and other communication.

### BACKGROUND

The present disclosure relates generally to social networking systems and methods. In particular, social networking systems and methods facilitating in-person interactions are described herein.

Known social networking systems and methods are not entirely satisfactory for the range of applications in which they are employed. For example, existing social networking systems and methods require the Internet, mobile electronic devices (e.g. iPhone® and Droid®), and/or wireless networks to be operational. Additionally, known social networking systems and methods are best suited for facilitating online interaction, and are not designed to facilitate in-person interaction. Moreover, known social networking systems and methods lack the ability to publicly communicate membership to a social networking service and/or a members interests without the use of a mobile electronic device connected to some form of network.

In addition, conventional social networking systems and methods lack the ability to disassociate or blacklist a user. Generally, a member of a social networking service may only add other users as friends, ignore a friend request, or remove a member as friend. These limited options are inefficient because users who are removed as friends are often aware that they are no longer friends, and/or aware that their friend request has been ignored. Additionally, conventional social networking systems and methods lack the ability to track and record members who use the social networking service to interact with other members in ways that may be considered socially unacceptable.

Other limitations of conventional social networking systems and methods are that these systems do not track and record in-person interaction or online interaction, do not distinguish between in-person interaction or online interaction, and do not provide rewards based on in-person interaction or online interaction.

Thus, there exists a need for social networking systems and methods that improve upon and advance the design of known social networking systems and methods. Examples of new and useful social networking systems and methods relevant to the needs existing in the field are discussed below.

Disclosure addressing one or more of the identified existing needs is provided in the detailed description below. References relevant to social networking systems and methods include U.S. Pat. Nos. and Publication Nos.: U.S. Pat. No. 7,545,784, 7,725,492, 7,756,753, 7,756,756, 20100070758, and 20100203909. The complete disclosures of the above patents and patent application publications are herein incorporated by reference for all purposes.

### SUMMARY

The present disclosure is directed to social networking systems and methods for facilitating in-person interactions. In one embodiment, the present invention includes a social networking method for facilitating in-person interaction between a first user and a second user located near the first user, including the steps of storing a user profile for the first user into a database accessible by a networked host computer, the user profile including interest information describing the first user's interests, cross referencing an interest information indicia with the interest information, providing the first user with an indicator that includes the interest information indicia and that is configured to communicate the interest information indicia to nearby users, providing the second user with the interest information of the first user upon the second user accessing the host computer and entering the interest information indicia as a search query. The invention may facilitate in-person interaction, electronic dating, social networking, and other communication.

### BRIEF DESCRIPTION OF THE DRAWINGS

FIG. 1 shows a schematic view of a computer.

FIG. 2 shows a schematic view of a social networking system including an indicator being displayed by a first user on an article of clothing and a second user nearby viewing the publicly displayed indicator.

FIG. 3 shows a schematic view of a social networking system including a first indicator being displayed by a first user on an article of clothing, a second indicator being broadcast by a mobile electronic device, and a third user nearby viewing the first indicator and receiving the second indicator on a receiving device.

FIG. 4 shows a first graphical user interface on a mobile electronic device.

FIG. 5 shows a second graphical user interface on a mobile electronic device.

FIG. 6 shows a schematic example of an indicator suitable for being embodied as a packet of data.

FIG. 7 shows a schematic example of an indicator suitable for being embodied as a physical display.

FIG. 8 shows a flow chart of a first method for facilitating in-person interaction between a first user and a second user.

FIG. 9 shows a flow chart of a second method for facilitating in-person interaction between a first user and a second user.

### DETAILED DESCRIPTION

The disclosed social networking systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various social networking systems and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various examples of the social networking systems and methods may be implemented using electronic circuitry configured to perform one or more functions. For example, with some embodiments of the invention, the social networking systems and methods may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

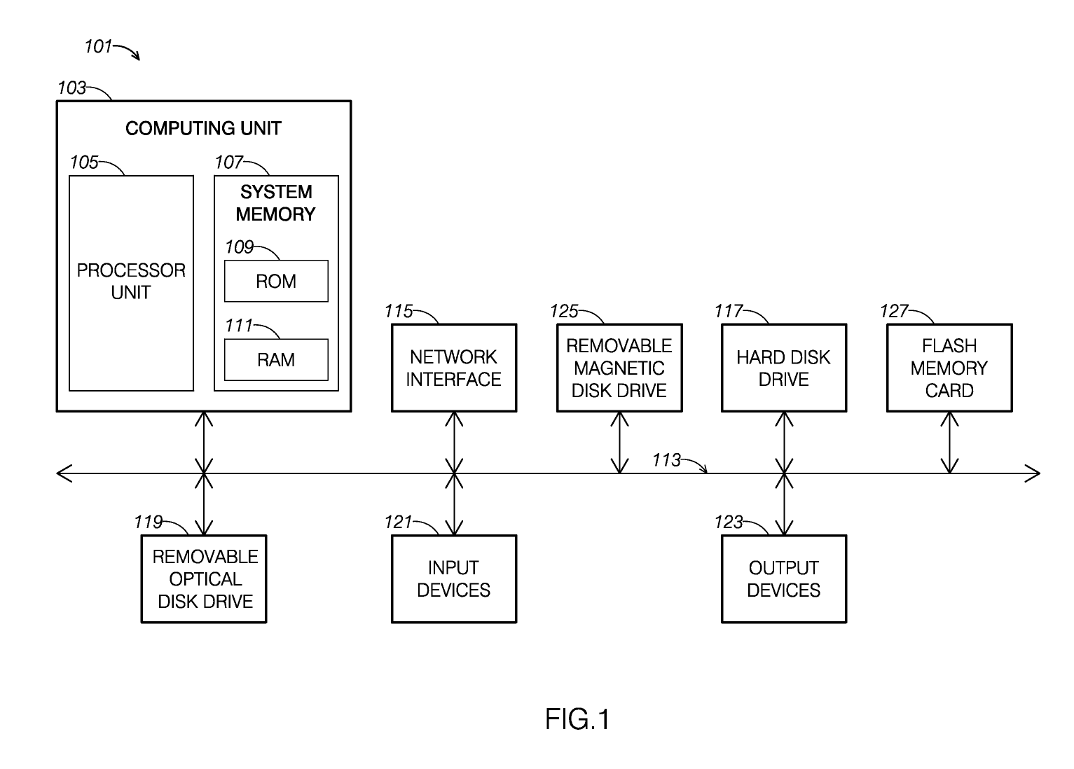

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or IPHONE® or Droid® brand smartphone available from Apple, Inc. of Cupertino, Calif. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone.” As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth ® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

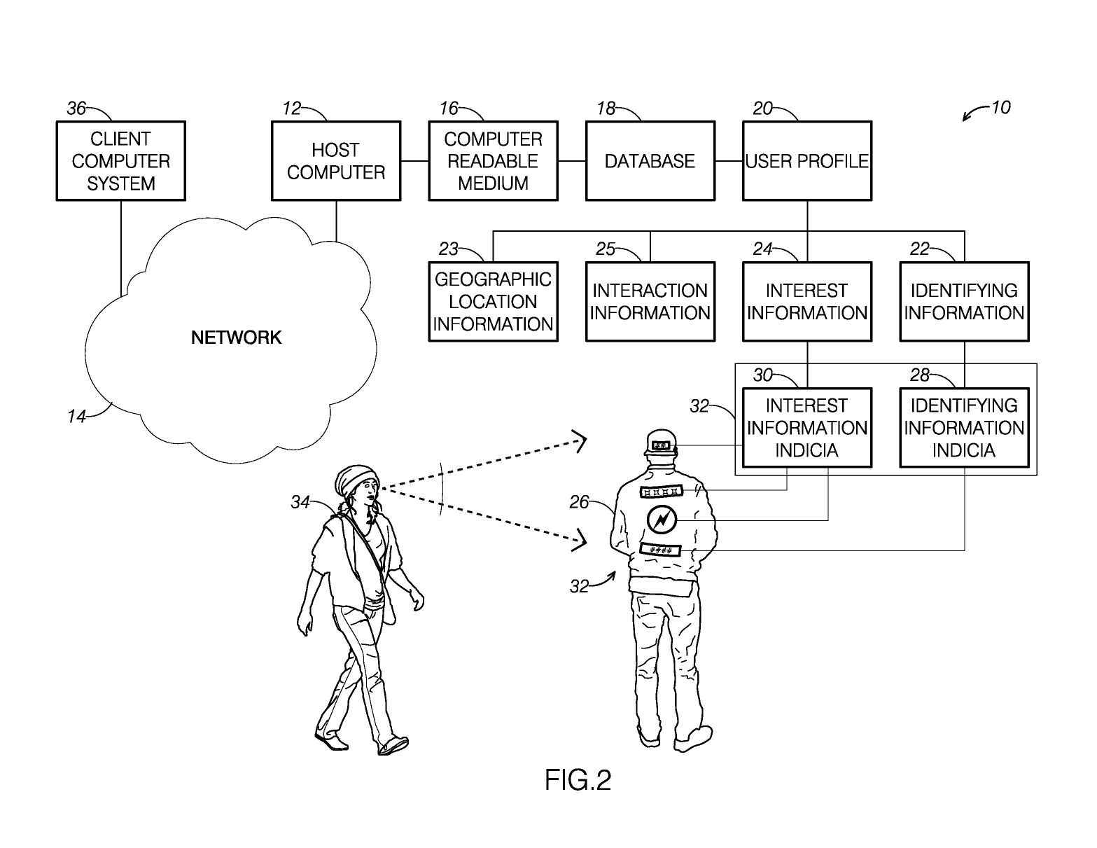

With reference to FIG. 2, a social networking system 10 includes a host computer system 12 connected to a network 14, and a computer readable medium 16 connected to host computer system 12. Social networking system 10 further includes a database 18 stored in computer readable medium 16, database 18 being configured to correlate data including one or more user profiles 20. User profiles 20 include identifying information 22 and interest information 24 for a given user 26. Social networking system 10 additionally includes an indicator 32.

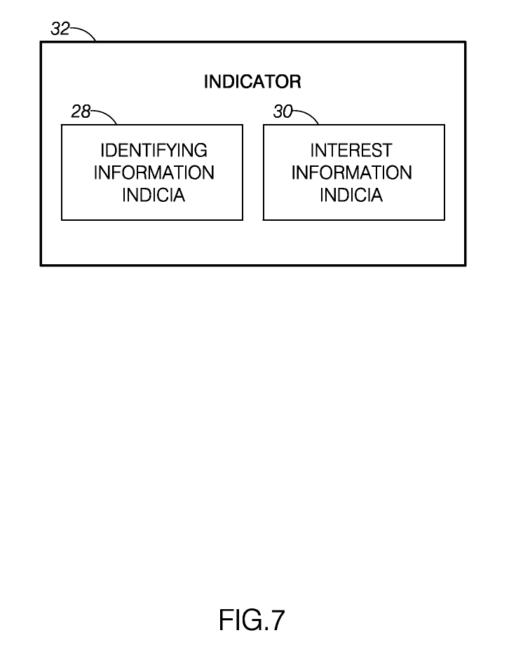

Turning attention to FIG. 7, a schematic example of indicator 32 suitable for being embodied as a as a physical display is shown. Indicator 32 includes identifying information indicia 28, which is cross referenced to identifying information 22 (shown in FIG. 2) in database 18 (shown in FIG. 2). Further, indicator 32 includes interest information indicia 30, which is cross referenced to interest information 24 (shown in FIG. 2) in database 18 (shown in FIG. 2).

Returning to FIG. 2, geographic location information 23 may include a given user's current geographic location, the location where a given user intends to be, and/or various locations that a given user has previously visited. Geographic location information 23 may be stored in database 18 and accessed and modified by a given user connecting to host computer system 12 via network 14 and client computer system 36 and entering a user name and the corresponding password. Additionally, other users may access a given user's geographic location information by connecting to host computer system 12 via network 14 and client computer system 36 and entering identifying information indicia 28 or interest information indicia 30 as a search query.

Interaction information 25 shown in FIG. 2 may include a given user's interactions with other users. For example, interaction information 25 may include information such as a given user's friends, disassociated or blacklisted users, and users who are unknown. Friends are other users of the social networking service that a given user knows. Disassociated or blacklisted users are those users that a given user would like to currently exclude from online and/or public interaction. The blacklisted or disassociated status, however, may be selectively turned off and on by a given user. Additionally, the blacklisted or disassociated user may or may not be aware of their status change. Unknown users are those users that are not blacklisted, disassociated, or listed as a friend.

Interaction information 25 may be stored in database 18 and accessed and modified by a given user connecting to host computer system 12 via network 14 and client computer system 36 and entering a user name and the corresponding password. Additionally, other users may access a given user's interaction information by connecting to host computer system 12 via network 14 and client computer system 36 and entering identifying information indicia 28 or interest information indicia 30 as a search query.

Indicator 32 is configured to allow given user 26 to publicly communicate identifying information indicia 28 and interest information indicia 30 to other nearby users, such as nearby user 34. Upon perceiving indicator 32, nearby user 34 can access user profile 20 corresponding to user 26 by connecting to host computer system 12 via network 14 and client computer system 36 and entering identifying information indicia 28 or interest information indicia 30 as a search query. Host computer 12 may include an appropriate user interface to enable users to enter search queries directed top identifying information indicia and interest information indicia.

Host computer system 12 may embody any of the features of computer 101 described in detail above. The network may be the Internet, a Local Area Network (“LAN”), a Wide Area Network (“WAN”), or a wireless network via a Virtual Private Network (“VPN”), for example, or a combination thereof. However, it should be understood that different networks could also be used.

Computer readable medium 16, as used herein, refers to any medium that participates in providing instructions to a processor unit for execution. Such a medium may take many forms, including but not limited to, non-volatile media and transmission media. Non-volatile media include, for example, optical or magnetic disks, such as storage devices. Volatile media include, for example, dynamic memory, such as main memory or random access memory (“RAM”). Common forms of computer readable media include, for example, floppy disks, flexible disks, hard disks, magnetic tape, punch cards, CD-ROM, or any other physical medium with patterns of holes, a RAM, a PROM, an EPROM, a FLASH-EPROM, and any other memory chip or cartridge, or any other medium from which a computer can read. However, it should be understood that different computer readable mediums could also be used.

Database 18 includes an organized collection of data, and database 18 is configured to correlate data for one or more purposes. Database 18 includes user profiles 20, which, as used herein, refers to a collection of data associated to a specific user. User profile 20 includes, among other things, identifying information 22 and interest information 24 for a given user 26.

The identifying information may include, for example, a user's unique login identity, password, name, address, date of birth, telephone number, photo, and/or email address. At least a portion of the identifying information may be labeled as private to keep the information from being publicly accessible. The interest information may include, for example, a user's likes and dislikes such as activities of interests (e.g. hiking, cycling, and/or jogging), movie taste, restaurant tastes, various online and/or offline groups a user belongs to, and so on and so forth. For other possible information to include in identifying information and interest information please see U.S. Pat. No. 7,545,784 directed to a system and method for wireless communication between previously known and unknown users.

In addition, database 18 includes data corresponding to identifying information indicia 28 cross referenced to identifying information 22 and data corresponding to interest information indicia 30 cross referenced to interest information 24. The identifying information indicia may be a physical or digital distinguishing marking such as a logo, unique number, unique color pattern, unique name, and/or unique data packet that indicates a user's membership to a social networking service that may be implemented on the social networking system. Similarly, the interest information indicia may be a physical or digital distinguishing marking such as a logo, unique number, unique color pattern, unique name, and/or unique data packet that indicates a user's various interests.

Indicator 32 is configured to allow a given user 26 to publicly communicate one or more identifying information indicia 28 and interest information indicia 30 to other nearby users 34. In other words, the indicator may include one or more identifying information indicia 28 and interest information indicia 30. In some examples, the indicator is a physical item, such as a shirt, hat, bumper sticker, or card displaying indicia in the form of a logo, unique number, unique color pattern, and/or unique name. Additionally, the indicator could be any personal article, such as a keychain, keychain article, or cup.

For example, in FIG. 2 indicator 32 includes a hat and a shirt displaying indicia to other nearby user 34. Indicator 32 allows other nearby users, including user 34, without aid of any electronic devices or the Internet, to recognize that a given user 26 is a member of the social networking service. Additionally, beyond recognizing that a given user 26 is a member of the social networking service, the indicator may also indicate one or more of the identifying information and interest information of a given user 26.

By publicly communicating indicator 32, nearby user 34 may decide to approach given user 26 due to curiosity or a shared interest in identifying information and interest information displayed by user 26, thereby facilitating social interaction between a given user 26 and the other nearby users. Again, this may be accomplished without the aid of any electronic devices or the Internet. Additionally, nearby users may use the one or more publicly communicated identifying information and interest information to learn more about a given user 26 and/or contact a given user 26 in the future.

For example, the other nearby users may use one or more of the publicly communicated identifying information indicia and interest information indicia to access a given user's user profile in the database. As discussed above, user profiles are accessible by users via the client computer systems connected to the host computer system via the network upon entering the one or more identifying information indicia and interest information indicia as a search query.

In other examples, the indicator may be a physical item configured to publicly communicate the one or more identifying information indicia and interest information indicia by wireless broadcast. For example, the one or more identifying information indicia and interest information indicia may be wirelessly broadcast via RFID (Radio-frequency identification), Bluetooth®, or other wireless signal.

A wireless broadcast capable indicator allows a given user to wirelessly broadcast the one or more identifying information indicia and interest information indicia to the other nearby users who have receiving devices capable of receiving and displaying the one or more identifying information indicia and interest information indicia. In this embodiment, the other nearby users may still memorize or write down the one or more identifying information indicia and interest information indicia, but do not have to in order to access user profiles in the future. Instead, the other nearby users may access user profiles using their receiving devices and/or their client computer systems at any time after receiving the one or more identifying information indicia and interest information indicia.

A wireless broadcast capable indicator, may be an RFID (Radio-frequency identification) tag as is understood by a person having ordinary skill in the art. RFID tags are common across many industries and frequently involve the use of an object applied to or incorporated into a product, animal, or person for the purpose of identification and tracking using radio waves. RFID tags can be read from several meters away and beyond the line of sight of the reader. RFID tags may be used to track products in a warehouse or to track files in an office. RFID tags may be incorporated into a physical item, such as a shirt, hat, bumper sticker, or card. The RFID tag may or may not be battery operated. Additionally, the RFID tag may be passive or active as is understood by a person having ordinary skill in the art.

In some examples, a given user may both display and broadcast indicators. Publicly communicating indicators by multiple means enables other nearby users to physically view the indicator and potentially approach the given user based on the indicia displayed on the indicator. However, in an environment where there are several users such as a crowd, it may be impracticable to read or view indicia displayed on an indicator. Concurrently broadcasting the indicator may be more practical for communicating the indicator in such environments.

Upon receiving a broadcast indicator, a nearby user may locate the given user by using a photo associated with the user profile to track down the given user. A photo may be accessible by using the received indicator to access the database and in turn access the user profile associated with the received indicator.

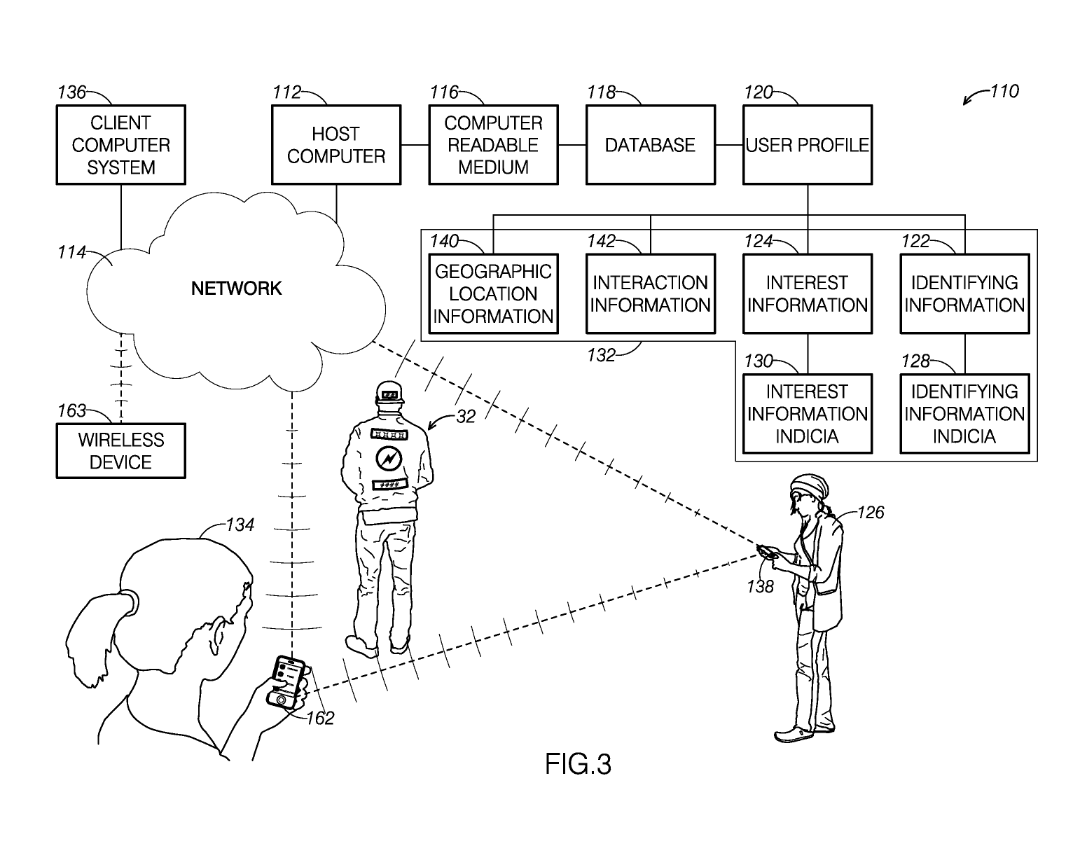

Turning attention to FIG. 3, a second example of a social networking system 110 will now be described. Social networking system 110 includes many similar or identical features to social networking system 10 combined in unique and distinct ways. Thus, for the sake of brevity, each feature of social networking system 110 will not be redundantly explained. Rather, key distinctions between social networking system 110 and social networking system 10 will be described in detail and the reader should reference the discussion above for features substantially similar between the two social networking systems and methods.

As can be seen in FIG. 3, social networking system 110 includes a host computer system 112 connected to a network 114, and a computer readable medium 116 connected to host computer system 112. Social networking system 110 further includes a database 118 stored in computer readable medium 116, database 118 being configured to correlate data including one or more user profiles 120. User profiles 120 include identifying information 122 and interest information 124 for a given user 126. Social networking system 110 additionally includes an indicator 132 including one or more identifying information indicia 128 and interest information indicia 130.

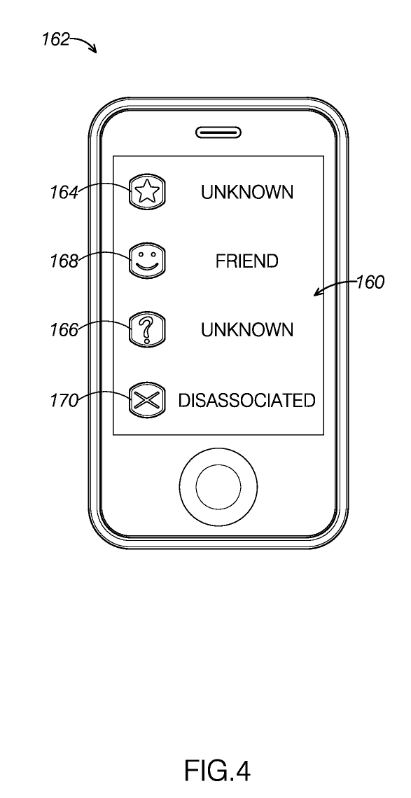

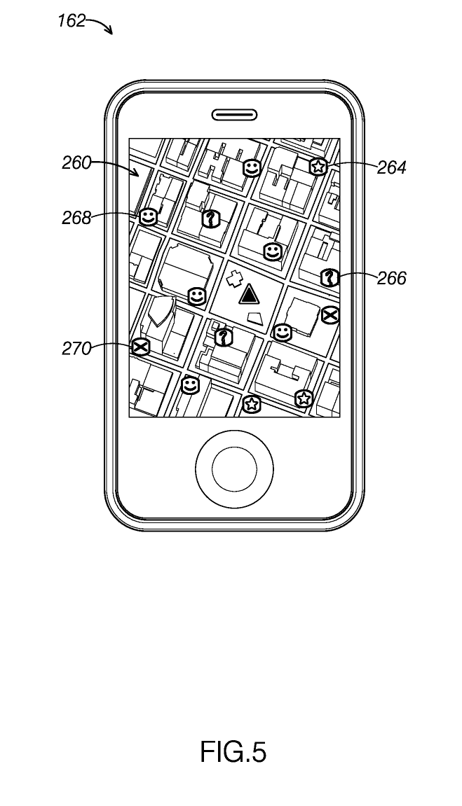

Indicator 132 is similar in many respects to indicator 32 (as shown in FIGS. 2 and 3) discussed above, except indicator 132 is a packet of information stored on a mobile electronic device 138 configured to broadcast information. As shown in FIG. 3, indicator 132 communicates one or more identifying information indicia 128 and interest information indicia 130 by being broadcast to other nearby users with receiving devices capable of receiving and displaying one or more identifying information indicia 128 and interest information indicia 130. With reference to FIG. 3, user 126 broadcasts indicator 132 with mobile electronic device 138 to receiving device 162 to be displayed to nearby user 134 via a graphical user interface. Examples of the graphical user interface displayed on mobile electronic device 162 are shown in FIGS. 4 and 5, which are discussed below.

In many ways indicator 132 performs similar functions as indicator 32, allowing other nearby users to receive publicly communicated identifying information indicia and interest information indicia from a given user. User 126 using mobile electronic device 138 to broadcast indicator 132 may additionally receive wirelessly broadcasted identifiers from other users with mobile electronic device 138. The ability of mobile electronic device 138 to send and receive indicators enables a user to actively locate, communicate with, and seek out other nearby users, in addition to passively broadcasting an indicator and waiting to be sought out by the other nearby users.

System 110 enables a given user to selectively broadcast identifying information indicia and interest information indicia to other nearby users. When the indicator is a physical item, such as a display on a shirt, a given user has limited control over who perceives the indicator. Likewise, when the indicator is a physical item that is wirelessly broadcasted a given user may only choose between publicly broadcasting the indicator or not.

However, when the indicator is a packet of information stored on a mobile electronic device, a given user may choose to selectively broadcast the indicator: 1) to friends that are users of the social networking service; 2) to not unknown users of the social networking service; and/or 3) to disassociated or blacklisted users of the social networking service.

Friends are other users of the social networking service that a given user knows. Disassociated or blacklisted users are those users that a given user would like to currently exclude from online and/or public interaction. The blacklisted or disassociated status, however, may be selectively turned off and on by a given user. Additionally, the blacklisted or disassociated user may or may not be aware of their status change. Unknown users are those users that are not blacklisted, disassociated, or listed as a friend.

Turning attention to FIG. 4, a first example of a graphical user interface 160 on mobile electronic device 162 is shown. In FIG. 4, graphical user interface 160 includes a first unknown user 164, a second unknown user 166, a friend 168, and a disassociated user 170. The users displayed in FIG. 4 may be other nearby users within broadcast range of the mobile electronic device. The various symbols used beside the user names and or identities may be a photo and/or an avatar associated with the other nearby users displayed on the graphical user interface. Additionally or alternatively, the symbols may be some other indicator such as compatibility between the user of the mobile electronic device and the other nearby users displayed on the graphical user interface. The lettering beside the symbols may be a user name, online identity, and/or some other pseudonym that may or may not be unique.

First unknown user 164 is indicated with a star symbol. This may indicate that first unknown user 164 is compatible with a given user who is operating the social networking service on the mobile electronic device. The star symbol may be several stars such as four or five stars possibly to indicate compatibility, or some other symbolic representation of compatibility may be used such as a check mark, a color, and/or a partially shaded box representing a percentage of compatibility. Similarly, second unknown user 166 is shown as a question mark. This may be to indicate that compatibility is uncertain or the social networking system has yet to determine compatibility with the second unknown user.

In some embodiments, a given user of a mobile electronic device may switch between avatar and/or photo mode, and compatibility mode. The avatar and/or photo mode may be useful for locating other nearby users. Where as, the compatibility mode may be useful for locating other nearby users who share similar interests or are compatible.

Graphical user interface 160 additionally shows friend 168 and disassociated user 170. These users are known users, previously labeled by the user as a friend and as a disassociated member, respectively.

The capability to blacklist or disassociate users allows a given user to avoid online and/or public interaction. This capability may allow a given user to be online and interacting with other users without the blacklisted or disassociated user's awareness. Additionally or alternatively, this capability may allow a given user to publicly interact with other users without the blacklisted or disassociated user's awareness. In other words, a given user and a blacklisted or disassociated user may be within broadcasting and receiving range in a public place, but the blacklisted or disassociated user would be unaware that a given user is nearby.

This feature could be employed to avoid interaction with a boss or co-worker on a day that a given user called in sick. Additionally or alternatively, this feature could be employed to avoid interaction with an ex-spouse, ex-boyfriend, or ex-girlfriend. Additionally or alternatively, another possible purpose behind blacklisting or disassociating a particular user may be to eliminate that user from being indicated as compatible or incompatible, as the case may be. In other words, the user of the social networking system may have already determined that the disassociated user is incompatible despite the possibility of being compatible according to the social networking system. As will be explained later, this feature of disassociating users may further allow the social networking system to track or monitor a blacklisted or disassociated user's interactions with the user that blacklisted or disassociated them.

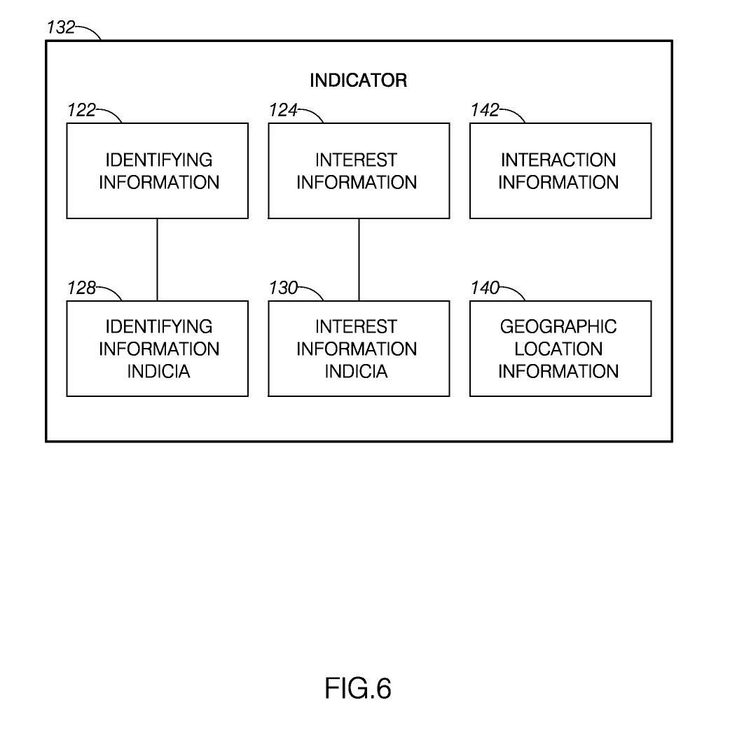

Turning attention to FIG. 6, a schematic example of indicator 132 suitable for being embodied as a packet of data is shown. Indicator 132 includes identifying information 122 and interest information 124 for a given user 126 (shown in FIG. 3). Indicator 132 includes identifying information indicia 128, which is cross referenced to identifying information 122 in database 118 (shown in FIG. 3). Moreover, indicator 132 includes interest information indicia 130, which is cross referenced to interest information 124 in database 118 (shown in FIG. 3). Additionally, indicator 132 includes geographic location information 140 and interaction information 142, both to be discussed in more detail below.

Additionally, the indicator may further include geographic location information corresponding to the present location of a given user at the time the indicator is broadcast. The geographic location information may include GPS information as well as a time and date stamp. A given user may selectively turn on or off the broadcast of geographic location information. The geographic location information contained within the indicator may be correlated to received indicators and recorded as interaction information. The interaction information may include the indicators received from users and the geographic location information corresponding to the location of the receiving device at the time the indicator is received.

The geographic location information may allow users to locate a given user. Additionally or alternatively, geographic location information received may allow users to correlate their interactions with other users based on date, time, and geographic location. This information may be helpful for remembering a newly acquainted user or for a follow up message. For example, when following up with a given user after an interaction, a user may review the geographic location information and include that information in the follow up message in order to further personalize the message and remind the other user of the interaction. For example, the geographic location information may include GPS data as well as the business name or event name for the physical location, such as the name of the restaurant, coffee shop, or the event (e.g. basketball game and concert).

Turning attention to FIG. 5, a second example of a graphical user interface 260 on a mobile electronic device 162 will now be described. Graphical user interface 260 includes many similar or identical features to graphical user interface 160 (shown in FIG. 4) combined in unique and distinct ways. Thus, for the sake of brevity, each feature of graphical user interface 260 will not be redundantly explained. Rather, key distinctions between graphical user interface 260 and graphical user interface 160 (shown in FIG. 4) will be described in detail and the reader should reference the discussion above for features substantially similar between the two graphical user interfaces.

Graphical user interface 260 (shown in FIG. 5), includes a first unknown user 264, a second unknown user 266, a friend 268, and a disassociated user 270. The users displayed in FIG. 4 may be other nearby users within broadcast range of the mobile electronic device. Graphical user interface 260 may provide a user of the mobile electronic device with geographic location information of the other nearby users. For example, the graphical user interface may display a series of streets and/or nearby businesses with representations of the other nearby users on the streets and/or at the nearby businesses. Additionally, a user may be able to pan the graphical user interface in various directions and zoom in or out the graphical user interface as the user sees fit. This may allow a user to locate the other nearby users more readily, thereby facilitating in-person communication with the other nearby users.

Turning attention back to social networking system 110, host computer 112 is configured to receive interaction information from the receiving devices. Additionally, host computer 112 further correlates the interaction information received with the user profile associated with the receiving device and the user profile contained within the indicator received by the receiving device.

The social networking system may further include a comparative system that uses the correlated interaction information to monitor user interactions. The comparative system may compare the interaction information received from the receiving devices to determine one or more of geographic proximity of users during interaction, geographic location of users during interaction, and whether users have had prior interactions.

The comparative system may further include a reward system based on user interactions. The reward system may assign rewards based on one or more of geographic proximity of interactions, geographic location of interactions, and whether users have had prior interactions e.g. whether the status of a given user and another user is either friends, unknown, not associated, or disassociated.

The reward system may award different point values to users that interact online, in public places, and who are “friends,” “unknown,” or “disassociated.” For example, the reward system may provide a first reward for users that interact online that are “friends,” a second reward for users that interact online that are “unknown,” a third reward for users that interact in public that are “friends,” a fourth reward for users that interact in public that are “unknown,” a fifth reward to users that refer new members to the social networking service, a sixth reward (that may be negative in value) to “disassociated” users that seek to interact either online or in public with a given user that “disassociated” them. The rewards may further be used to obtain additional membership features and/or to purchase items similar to other reward programs.

The comparative system may further be configured to monitor interaction between a first user and a second user when the first user has disassociated the second user, including the proximity of the second user to the first user. This feature allows the social networking system to monitor socially unacceptable behavior such as stalking and to deter such behavior by subtracting reward points, limiting membership features such as geographic location information of other nearby users, and/or prohibiting such behavior by canceling a disassociated user's membership. Additionally, the interaction information may be stored electronically and accessed for evidentiary purposes in case a given user wishes to file a complaint against a disassociated user.

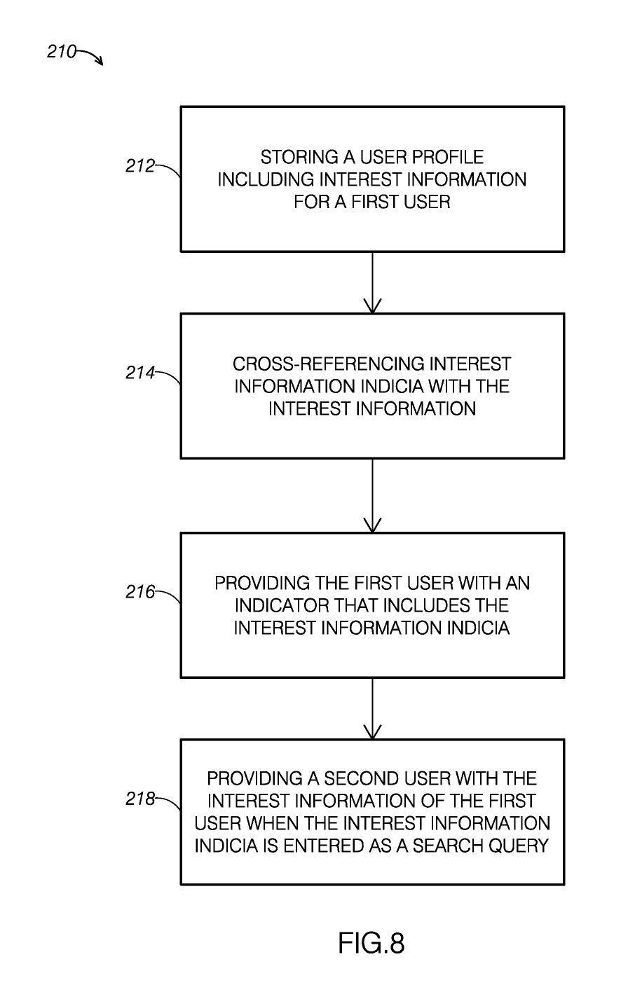

As shown in FIG. 8, a social networking method 210 includes storing a user profile, which includes interest information for a first user at step 212, cross referencing interest information indicia with the interest information at step 214, providing the first user with an indicator, which includes the interest information indicia at step 216, and providing a second user with the interest information of the first user at step 218 when the interest information indicia is entered as a search query.

The user profile at step 212 includes interest information and may include identifying information. The interest information may include, for example, a user's likes and dislikes such as activities of interests (e.g. hiking, cycling, and/or jogging), movie taste, restaurant tastes, various online and/or offline groups a user belongs to, and so on and so forth. The identifying information may include, for example, a user's unique login identity, password, name, address, date of birth, telephone number, photo, and/or email address. For other possible information to include in identifying information and interest information please see U.S. Pat. No. 7,545,784 directed to a system and method for wireless communication between previously known and unknown users.

In addition, the method includes interest information indicia cross referenced to interest information and may include identifying information indicia cross referenced to identifying information. The identifying information indicia may be a physical or digital distinguishing marking such as a logo, unique number, unique color pattern, unique name, and/or unique data packet that indicates a user's membership to a social networking service. Similarly, the interest information indicia may be a physical or digital distinguishing marking such as a logo, unique number, unique color pattern, unique name, and/or unique data packet that indicates a user's various interests.

The indicator provided to the first user may be a physical item configured to publicly communicate the interest information indicia and/or identifying information indicia by displaying the interest information indicia and/or identifying information indicia. Additionally, the social networking method may further include a mobile electronic device configured to broadcast information. Moreover, the indicator may be a packet of information stored on a mobile electronic device and the indicator may communicate the interest information indicia and/or identifying information indicia by being broadcast to users with receiving devices capable of receiving and displaying the interest information indicia and/or identifying information indicia.

The indicator may additionally include geographic location information corresponding to the present location of the given user at the time the indicator is broadcast. Moreover, the host computer may be configured to receive the geographic location information from the receiving devices. Furthermore, the host computer may utilize the geographic location information of the first user and the geographic location information of the second user to record interactions between the first user and the second user.

A second user may be provided with interest information and/or identifying information of the first user upon the second user accessing the host computer and entering the interest information indicia as a search query. The host computer may be accessible via a client computer system attached to the host computer via a network. Additionally, the second user may employ a mobile electronic device to interact with the host computer over a wired or wireless network to obtain the interest information and/or identifying information. Provided the mobile electronic device is capable of receiving and displaying interest information indicia and/or identifying information indicia.

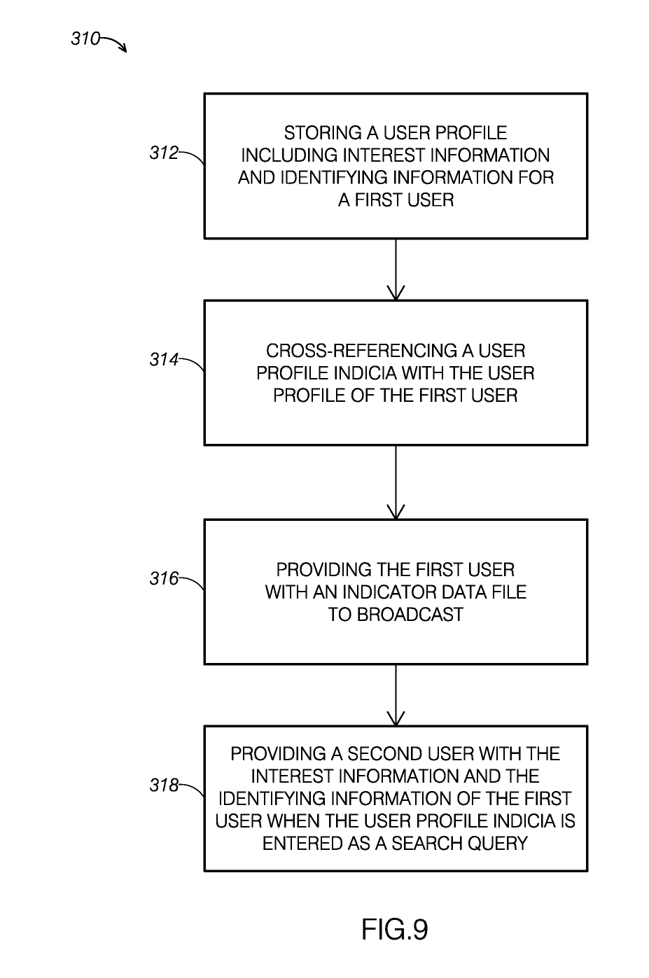

Turning attention to FIG. 9, a second example of a social networking method will now be described. Social networking method 310 includes many similar or identical features to social networking method 210 combined in unique and distinct ways. Thus, for the sake of brevity, each feature of social networking method 310 will not be redundantly explained. Rather, key distinctions between social networking method 310 and social networking method 210 will be described in detail and the reader should reference the discussion above for features substantially similar between the two social networking methods.

As shown in FIG. 9, a social networking method 310 includes storing a user profile, which includes interest information and identifying information for a first user at step 312, cross referencing a user profile indicia with the user profile of the first user at step 314, providing the first user with an indicator data file to broadcast at step 316, and providing a second user with the interest information and the identifying information of the first user at step 318 when the user profile indicia is entered as a search query.

The user profile may be stored in a database accessible by a host computer via a network. The database may cross reference a user profile indicia with the user profile of the first user.

The indicator data file may include the user profile indicia and may be configured to be stored on a mobile electronic device configured to broadcast the user profile indicia to nearby users. A second user may be provided with the interest information and the identifying information of the first user upon the second user accessing the host computer and entering the user profile indicia as a search query. The host computer may be accessible via a client computer connected to the network and/or via a mobile electronic device connected to the network.

The indicator may additionally include geographic location information corresponding to the present location of the given user at the time the indicator is broadcast. Moreover, the host computer may be configured to receive the geographic location information from the receiving devices. Furthermore, the host computer may utilize the geographic location information of the first user and the geographic location information of the second user to record interactions between the first user and the second user.

The social networking method may further include a comparative system configured to monitor interactions between the first user and the second user and assign rewards to the first user and second user based on the interaction information received. The rewards may be based on the determination by the comparative system of one or more of the following: geographic proximity of interactions, geographic location of interactions, and whether the first and second users have had prior interactions.

The reward system may award different point values to users that interact online, in public places, and who are associated, not associated, or disassociated. For example, the reward system may provide a first reward for users that interact online that are associated, a second reward for users that interact online that are not associated, a third reward for users that interact in public that are associated, a fourth reward for users that interact in public that are not associated, a fifth reward to users that refer new members to the social networking service, a sixth reward (that may be negative in value) to disassociated users that seek to interact either online or in public with a given user that disassociated them. The rewards may further be used to obtain additional membership features and/or to purchase items similar to other reward programs.

The comparative system may further be configured to monitor interaction between a first user and a second user when the first user has disassociated the second user, including the proximity of the second user to the first user. This feature allows the social networking system to monitor socially unacceptable behavior such as stalking and deter such behavior by subtracting reward points, limiting membership features such as geographic location information of other nearby users, and/or prohibiting such behavior by canceling a disassociated user's membership. Additionally, the interaction information may be stored electronically and accessed for evidentiary purposes in case a given user wishes to file a complaint against a disassociated user.

The comparative system may assign different reward values to users that interact online, in public places, and who are “friends,” “unknown,” or “disassociated.” For example, the reward system may provide a first reward for users that interact online that are “friends,” a second reward for users that interact online that are “unknown,” a third reward for users that interact in public that are “friends,” a fourth reward for users that interact in public that are not associated, a fifth reward to users that refer new members to the social networking service, a sixth reward (that may be negative in value) to “disassociated” users that seek to interact either online or in public with a given user that “disassociated” them. The rewards may further be used to obtain additional membership features and/or to purchase items similar to other reward programs.

The comparative system may further be configured to monitor interaction between a first user and a second user when the first user has disassociated the second user, including the proximity of the second user to the first user. This feature allows the social networking system to monitor socially unacceptable behavior such as stalking and to deter such behavior by subtracting reward points, limiting membership features such as geographic location information of other nearby users, and/or prohibiting such behavior by canceling a disassociated user's membership.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A social networking system, comprising:
a host computer system connected to a network;
a computer readable medium connected to the host computer system;
a database stored in the computer readable medium, the database configured to correlate data including:
user profiles including identifying information and interest information for a given user, and
identifying information indicia cross referenced to the identifying information, and
interest information indicia cross referenced to the interest information; and
an indicator including one or more of the identifying information indicia and the interest information indicia, the indicator being configured to allow a given user to publicly communicate one or more of the identifying information indicia and the interest information indicia to other nearby users;
wherein the user profiles in the database are accessible by users via client computer systems connected to the host computer system via the network upon entering one or more of the identifying information indicia and the interest information indicia.

2. The social networking system of claim 1, wherein the indicator is a physical item configured to publicly communicate one or more of the identifying information indicia and the interest information indicia by displaying one or more of the identifying information indicia and the interest information indicia.

3. The social networking system of claim 1, wherein the indicator is a physical item configured to publicly communicate one or more of the identifying information indicia and the interest information indicia by wirelessly broadcasting one or more of the identifying information indicia and the interest information indicia.

4. The social networking system of claim 1, further comprising a mobile electronic device configured to broadcast information;
wherein the indicator is a packet of information stored on the mobile electronic device and the indicator communicates one or more of the identifying information indicia and the interest information indicia by being broadcast to users with receiving devices capable of receiving and displaying one or more of the identifying information indicia and the interest information indicia.

5. The social networking system of claim 4, wherein the indicator further includes geographic location information corresponding to the present location of the given user at the time the indicator is broadcast.

6. The social networking system of claim 5, wherein the receiving devices record interaction information;
the interaction information including indicators received and geographic location information corresponding to the location of the receiving device at the time the indicator is received.

7. The social networking system of claim 6, wherein the host computer is configured to receive the interaction information from the receiving devices.

8. The social networking system of claim 7, further comprising a comparative system configured to monitor user interactions;
wherein the comparative system compares the interaction information received from the receiving devices to determine one or more of geographic proximity of users during interaction, geographic location of users during interaction, and whether users have had prior interactions.

9. The social networking system of claim 8, wherein the comparative system assigns rewards based on the interaction information received, including rewards based on one or more of geographic proximity of interactions, geographic location of interactions, and whether users have had prior interactions.

10. The social networking system of claim 8, wherein the comparative system further determines if users are labeled as friend, unknown, or disassociated.

11. The social networking system of claim 10, wherein the comparative system is configured to record an interaction between a first user and a second user when the first user has disassociated the second user, including the proximity of the second user to the first user.

12. A social networking method for facilitating in-person interaction between a first user and a second user located near the first user, comprising the steps of:
storing a user profile for the first user into a database accessible by a networked host computer, the user profile including interest information describing the first user's interests;
cross referencing an interest information indicia with the interest information in the database;
providing the first user with an indicator that includes the interest information indicia and that is configured to communicate the interest information indicia to nearby users;
providing, with a microprocessor, the second user with the interest information of the first user upon the second user accessing the host computer and entering the interest information indicia as a search query.

13. The social networking method of claim 12 wherein the indicator is a physical item configured to publicly communicate the interest information indicia by displaying the interest information indicia.

14. The social networking method of claim 12, further comprising a mobile electronic device configured to broadcast information;
wherein the indicator is a packet of information stored on the mobile electronic device and the indicator communicates the interest information indicia by being broadcast from the first user to the second user with a receiving device capable of receiving and displaying the interest information indicia.

15. The social networking method of claim 14, wherein the indicator further includes geographic location information corresponding to the present location of the first user at the time the indicator is broadcast.

16. The social networking method of claim 15, further comprising recording interactions between the first user and the second user with the host computer based on the geographic location information of the first user and the geographic location information of the second user.

17. A social networking method for facilitating in-person interaction between a first user and a second user located near the first user, comprising the steps of:
storing a user profile for the first user into a database accessible by a networked host computer, the user profile including interest information describing the first user's interests and identifying information uniquely identifying the first user;
cross referencing, with a microprocessor, a user profile indicia with the user profile of the first user;
providing the first user with an indicator data file that includes the user profile indicia and that is configured to be stored on a mobile electronic device configured to broadcast the user profile indicia to nearby users;
providing, with a microprocessor, the second user with the interest information and the identifying information of the first user upon the second user accessing the host computer and entering the user profile indicia as a search query.

18. The social networking method of claim 17, wherein the indicator further includes geographic location information corresponding to the present location of the first user at the time the indicator is broadcast.

19. The social networking method of claim 18, further comprising recording interactions between the first user and the second user with the host computer based on the geographic location information of the first user and the geographic location information of the second user.

20. The social networking method of claim 19, further comprising:
monitoring, with a microprocessor, interactions between the first user and the second user;
comparing the monitored interaction information to determine one or more of the geographic proximity of users while interacting, the geographic location of users while interacting, and whether users have had prior interactions; and
assigning rewards to the first user and second user based on one or more of geographic proximity of interactions, geographic location of interactions, and whether users have had prior interactions.
